(19) United States
(12) Patent Application Publication
(10) Pub. No.: US 2021/0381981 A1
(43) Pub. Date: Dec. 9, 2021

(54) GAS SENSOR ELEMENT AND GAS DETECTION DEVICE FORMED FROM THE SAME

(71) Applicant: Panasonic Intellectual Property Management Co., Ltd., Osaka (JP)

(72) Inventors: HIROAKI YOSHIDA, Osaka (JP); YOSHIE TAKAHASHI, Osaka (JP); KAZUTO FUKUDA, Osaka (JP); RYOUHEI SEKI, Tokyo (JP)

(21) Appl. No.: 17/241,801

(22) Filed: Apr. 27, 2021

(30) Foreign Application Priority Data
Jun. 5, 2020 (JP) 2020-098708

(51) Int. Cl. G01N 21/64

(52) U.S. Cl. CPC G01N 21/6428; G01N 2201/06193

(57) ABSTRACT

A gas sensor element includes: a supporting base material; a first light-emitting layer that is provided on the supporting base material and contains a first light-emitting particle which emits light at a first peak wavelength; a sensor layer that is provided on the first light-emitting layer and adsorbs gas molecules; a second light-emitting layer that is provided on the sensor layer and contains a second light-emitting particle which emits light at a second peak wavelength different from the first peak wavelength; and a protective layer that is provided on the second light-emitting layer, in which the gas sensor element has a laminated structure in which the supporting base material, the first light-emitting layer, the sensor layer, the second light-emitting layer, and the protective layer are laminated in this order, and the laminated structure includes an opening that penetrates a part or entirety of the laminated structure.

### BACKGROUND

### 1. Technical Field

The present disclosure relates to a gas sensor element used for gas detection, and a gas detection device formed from the gas sensor element.

### 2. Description of the Related Art

In the related art, a semiconductor type sensor has been used as a gas sensor capable of sensing various types of gases such as flammable gas and toxic gas. The semiconductor type sensor is mainly composed of a heater coil, a metal oxide semiconductor element, and an electrode for measuring electric resistance of the semiconductor element. In the semiconductor type sensor, in a state in which the metal oxide semiconductor element is heated by the heater coil, an electrochemical reaction occurring between a detection target gas and the metal oxide semiconductor element changes an electric resistance value of the metal oxide semiconductor element, and thereby the gas can be detected. Furthermore, by adding impurities to the metal oxide semiconductor, it is possible to impart selectivity according to gases to change in electric resistance value depending on detection target gases.

As a method for detecting a plurality of types of gases using one semiconductor type sensor, there is a gas sensing device as disclosed in Japanese Patent No. 6309062. Japanese Patent No. 6309062 discloses a method for sensing concentrations of various gases from a resistance value of a metal oxide semiconductor by investigating an influence of each gas type on an electric resistance value of the metal oxide semiconductor, and considering this influence.

### SUMMARY

In order to solve the above-mentioned problems, a gas sensor element according to the present disclosure includes:

a supporting base material;

a first light-emitting layer that is provided on the supporting base material and contains a first light-emitting particle which emits light at a first peak wavelength;

a sensor layer that is provided on the first light-emitting layer and adsorbs gas molecules;

a second light-emitting layer that is provided on the sensor layer and contains a second light-emitting particle which emits light at a second peak wavelength different from the first peak wavelength; and

a protective layer that is provided on the second light-emitting layer,

in which the gas sensor element has a laminated structure in which the supporting base material, the first light-emitting layer, the sensor layer, the second light-emitting layer, and the protective layer are laminated in this order, and

the laminated structure includes an opening that penetrates a part or entirety of the laminated structure.

### BRIEF DESCRIPTION OF THE DRAWINGS

FIG. 1 is a schematic structural cross-sectional view showing a cross-sectional structure of a gas sensor element according to a first exemplary embodiment;

FIG. 2 is a schematic view showing a configuration of a gas detection device formed from the gas sensor element according to the first exemplary embodiment;

FIG. 3 is a graph showing a light emission spectrum before gas detection in a gas detection method according to the first exemplary embodiment;

FIG. 4 is a graph showing a light emission spectrum after the gas detection in the gas detection method according to the first exemplary embodiment; and

FIG. 5 is Table 1 showing conditions and gas concentration indices in an example and comparative examples.

### DETAILED DESCRIPTION

In the configuration of the related art, there is a problem that it is difficult to detect a gas at a concentration of 0.1 ppm or less because an electric resistance of the metal oxide semiconductor does not change for this gas.

An object of the present disclosure is to solve the above-mentioned problem in the related art, and to provide a gas sensor element and a gas detection device which are capable of detecting a gas at a concentration of 0.1 ppm or less because the gas sensor element reacts even with a gas at a low concentration.

A gas sensor element of a first aspect includes:

a supporting base material;

a first light-emitting layer that is provided on the supporting base material and contains a first light-emitting particle which emits light at a first peak wavelength;

a sensor layer that is provided on the first light-emitting layer and adsorbs gas molecules;

a second light-emitting layer that is provided on the sensor layer and contains a second light-emitting particle which emits light at a second peak wavelength different from the first peak wavelength; and

a protective layer that is provided on the second light-emitting layer,

in which the gas sensor element has a laminated structure in which the supporting base material, the first light-emitting layer, the sensor layer, the second light-emitting layer, and the protective layer are laminated in this order, and

an opening that penetrates a part or entirety of the laminated structure is provided.

According to the first aspect, in the gas sensor element of a second aspect, the opening may penetrate the laminated structure from the protective layer until at least the sensor layer is exposed.

According to the first or second aspect, in the gas sensor element of a third aspect, a film thickness of the sensor layer may be greater than or equal to 1 nm and less than or equal to 100 nm.

According to any one of the first to third aspects, in the gas sensor element of a fourth aspect, the second peak wavelength of the light, which is emitted from the second light-emitting particle contained in the second light-emitting layer may be different from the first peak wavelength of the light, which is emitted from the first light-emitting particle contained in the first light-emitting layer, by at least 10 nm or greater, when measured in accordance with a method in General rules for fluorometric analysis of the Japanese Industrial Standards (JIS K 0120).

A gas detection device of a fifth aspect includes:

the gas sensor element of any one of the first to fourth aspects;

an excitation energy source that causes the gas sensor element to emit light; and

a light receiver that receives light emitted from the gas sensor element by the excitation energy source.

As described above, according to the gas sensor element according to the present disclosure, and the gas detection device, which is formed from the gas sensor element, according to the present disclosure, even when a concentration of a detection target gas is 0.1 ppm or less, emission spectra of the first light-emitting layer and the second light-emitting layer are changed by changing a film thickness of the sensor layer, and thereby it is possible to detect a gas at a concentration of 0.1 ppm or less.

Hereinafter, the gas sensor element according to the exemplary embodiment and the gas detection device according to the exemplary embodiment will be described with reference to the drawings. In the drawings, substantially the same members are designated by the same reference numerals.

### First Exemplary Embodiment

### Gas Sensor Element

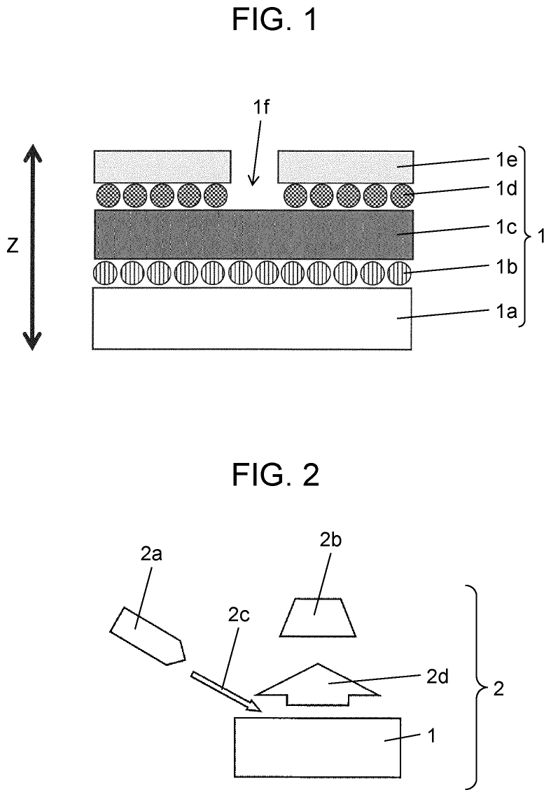

FIG. 1 is a schematic cross-sectional view showing a cross-sectional structure of gas sensor element 1 according to the first exemplary embodiment. Gas sensor element 1 according to the first exemplary embodiment has a laminated structure in which first light-emitting layer 1b, sensor layer 1c, second light-emitting layer 1d, and protective layer 1e are laminated in this order from a surface of supporting base material 1a, on plate-shaped supporting base material 1a. First light-emitting layer 1b contains a first light-emitting particle which emits light at a first peak wavelength. Sensor layer 1c adsorbs gas molecules. Second light-emitting layer 1d contains a second light-emitting particle which emits light at a second peak wavelength different from the first peak wavelength. Furthermore, gas sensor element 1 has opening 1f that penetrates the laminated structure from protective layer 1e until at least sensor layer 1c is exposed, in an in-plane vertical direction Z.

According to this gas sensor element, even when a concentration of a detection target gas is 0.1 ppm or less, emission spectra of first light-emitting layer 1b and second light-emitting layer 1d are changed by changing a film thickness of sensor layer 1c, and thereby it is possible to detect a gas at a concentration of 0.1 ppm or less.

The members constituting gas sensor element 1 will be described below.

### Supporting Base Material

Supporting base material 1a may be any member as long as first light-emitting layer 1b can be formed into a film on supporting base material 1a. For example, it is possible to use a polymer film such as PET, a glass substrate, and the like.

### First Light-Emitting Layer

First light-emitting layer 1b is formed by laminating first light-emitting particles (for example, semiconductor particles) which have a property of emitting light at a first peak wavelength by absorbing excitation energy. As the first light-emitting particles, the following particles are used: semiconductor nanoparticles having, as a core, cadmium sulfide, cadmium selenide, cadmium telluride, zinc sulfide, zinc selenide, zinc telluride, copper indium sulfide, silver indium sulfide, indium phosphide, or the like; cesium lead halide perovskite-type semiconductor nanoparticles; and semiconductor nanoparticles having silicon, carbon, or the like as a core. Instead of the semiconductor particles, it is also possible to use organic colorants, such as merocyanine and perylene, for which Førster resonance energy transfer to be described later has been reported. A lamination method is not particularly limited, and examples thereof include a Layer-by-Layer method (hereinafter, also referred to as an “LBL method”). The LBL method is a method in which a base material to be formed into a film is alternately immersed in a dilute solution of a cationic compound and a dilute solution of an anionic compound, an electrolyte polymer is spontaneously adsorbed on the base material, and thereby a film is formed. With this method, it is easy to control a material at a molecular level, and productivity also becomes excellent. Alternatively, instead of laminating the light-emitting particles, the light-emitting particles may be dispersed in a glass phase and enclosed in first light-emitting layer 1b.

### Sensor Layer

A material of sensor layer 1c is required to have both film forming properties on first light-emitting layer 1b and film forming properties on second light-emitting layer 1d, and adsorption properties with respect to a detection target gas. A method of forming a film on first light-emitting layer 1b is not particularly limited, but it is possible to use a method, in which thin film formation is controllable, such as the LBL method or a spin coater method. The material of sensor layer 1c is not particularly limited, but it is partially limited by a method to be adopted. For example, in the LBL method, it is possible to use polyallylamine and polydiallyldimethylammonium chloride as a cationic polymer, and ionic polymers such as polyacrylic acid, polystyrene sulfonic acid, and polyisoprene sulfonic acid as an anionic polymer; and in the spin coater method, the material is not particularly limited as long as it is a dissolvable material, and it is possible to use the above-mentioned ionic polymers, a silicone resin, polyvinyl chloride, polyurethane, polyvinyl alcohol, polypropylene, polyacrylamide, polycarbonate, polyethylene terephthalate, and the like.

By selecting a material of sensor layer 1c and changing conditions for a film formation process for sensor layer 1c, the higher-order structure of the polymer can be controlled, and thereby it is possible to impart selectivity of a gas to be adsorbed to sensor layer 1c. A thickness of sensor layer 1c is, for example, greater than or equal to 1 nm and less than 1 μm, and it is preferably less than or equal to 100 nm. When a thickness is less than 1 nm, sensor layer 1c cannot stably adsorb a detection target gas. When a thickness is greater than or equal to 1 μm, a distance between first light-emitting layer 1b and second light-emitting layer 1d becomes excessively far from each other, and an emission spectrum of the gas sensor element is changed due to Førster resonance energy transfer to be described later (hereinafter, also referred to as a “FRET phenomenon”) occurring before and after the adsorption of a detection target gas. The light described in the present specification is not limited to electromagnetic waves in the visible light range.

### Second Light-Emitting Layer

Second light-emitting layer 1d is formed by laminating second light-emitting particles (for example, semiconductor particles) which have a property of emitting light at a second peak wavelength that is different from the first peak wavelength by absorbing excitation energy. As the second light-emitting particles, the following particles are used: semiconductor nanoparticles having, as a core, cadmium sulfide, cadmium selenide, cadmium telluride, zinc sulfide, zinc selenide, zinc telluride, copper indium sulfide, silver indium sulfide, indium phosphide, or the like; cesium lead halide perovskite-type semiconductor nanoparticles; and semiconductor nanoparticles having silicon, carbon, or the like as a core. Instead of the semiconductor particles, it is also possible to use organic colorants, such as merocyanine and perylene, for which Førster resonance energy transfer to be described later has been reported. A lamination or deposition method is not particularly limited, but examples thereof include the LBL method. Alternatively, instead of laminating the light-emitting particles, the light-emitting particles may be dispersed in a glass phase and enclosed in second light-emitting layer 1d.

The second peak wavelength is required to be different from the first peak wavelength by 10 nm or more, where the second peak wavelength is a peak wavelength of light emitted from the second light-emitting particles, such as semiconductor particles or organic colorants, which constitute second light-emitting layer 1d, and the first peak wavelength is a peak wavelength of the first light-emitting particles constituting first light-emitting layer 1b. When a difference between light emission peaks of first light-emitting layer 1b and second light-emitting layer 1d is less than 10 nm, a change in emission spectrum of the gas sensor element is unlikely to be detected due to the FRET phenomenon to be described later.

### Protective Layer

A substance constituting protective layer 1e is required to have a function of chemically and physically protecting second light-emitting layer 1d. Furthermore, it is preferably a substance that can transmit 30% or more of each of light emitted from first light-emitting layer 1b and second light-emitting layer 1d and light emitted from an excitation energy source in order to facilitate measurement of an emission spectrum of gas sensor element 1. As the material, it is possible to use, for example, a polymer material such as silicon dioxide or an alicyclic epoxy resin; or a thin film formed of a metal such as Pt, Au, Ti, and Al or a compound thereof.

### Opening

Opening 1f is required to penetrate the laminated structure from protective layer 1e until sensor layer 1c is exposed, in the in-plane vertical direction Z of gas sensor element 1. It may penetrate the laminated structure up to first light-emitting layer 1b and supporting base material 1a. A shape of opening 1f in an in-plane direction of gas sensor element 1 may be a hole shape or a groove shape, and it may be any shape. Furthermore, a shape of opening 1f in the vertical direction Z of gas sensor element 1 may be a rectangular shape or a tapered shape, and it also may be any shape. Each area in a film surface in-plane direction, which is occupied by opening 1f, in protective layer 1e and second light-emitting layer 1d is preferably greater than or equal to 1% and less than 50%. When an area of opening 1f is less than 1%, sensor layer 1c is unlikely to adsorb a detection target gas, and when an area thereof is 50% or more, an intensity of light emitted from second light-emitting layer 1d becomes low. It is preferable that a plurality of openings 1f be formed as uniformly as possible in the entirety of gas sensor element 1 in order to cause sensor layer 1c to easily adsorb a detection target gas. A means to create the opening may be any means as long as the laminated structure of gas sensor element 1 is maintained. Examples of methods thereof include, but are not limited to, dry etching, wet etching, laser hole piercing, and the like.

Furthermore, both surfaces of supporting base material 1a may have the above-described film configuration in order to improve emission intensity from gas sensor element 1. In this case, it is desired to detect light emitted from each of first light-emitting layer 1b and second light-emitting layer 1d which are formed on the both surfaces of supporting base material 1a. Therefore, as supporting base material 1a, it is preferable to select a material that can transmit 30% or more of each of light emitted from first light-emitting layer 1b and second light-emitting layer 1d and light emitted from excitation energy source 2a.

Next, the principle of gas detection in the gas sensor element according to the first exemplary embodiment will be described. As a plurality of light-emitting particles, a case in which a fluorescence spectrum of one kind (donor) of the light-emitting particles and an excitation spectrum of the other kind (acceptor) of the light-emitting particles overlap each other is thought. In this case, there is a known mechanism in which, when these two kinds of light-emitting particles are close to each other, an excitation energy excites the acceptor before the donor excited by this excitation energy emits light. This mechanism is called Førster resonance energy transfer (FRET phenomenon) which depends on a distance between the donor light-emitting particles that emit light and the acceptor light-emitting particles.

A case in which semiconductor nanoparticles are used for both of the donor and the acceptor will be described. Semiconductor nanoparticles are nano-sized particles having semiconductor crystals, and have a characteristic in which an emission spectrum changes according to particle sizes due to the quantum size effect. Furthermore, they are particles having a characteristic in which an emission spectrum changes according to different materials even when particle sizes are the same, and thereby they can realize various emission spectra.

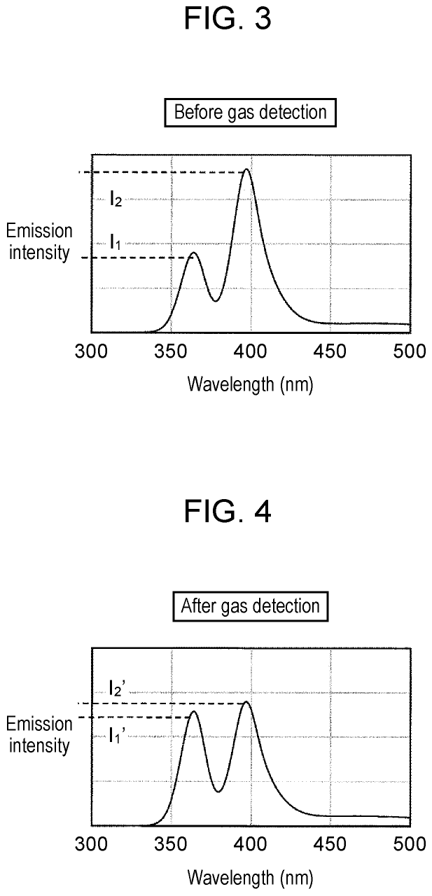

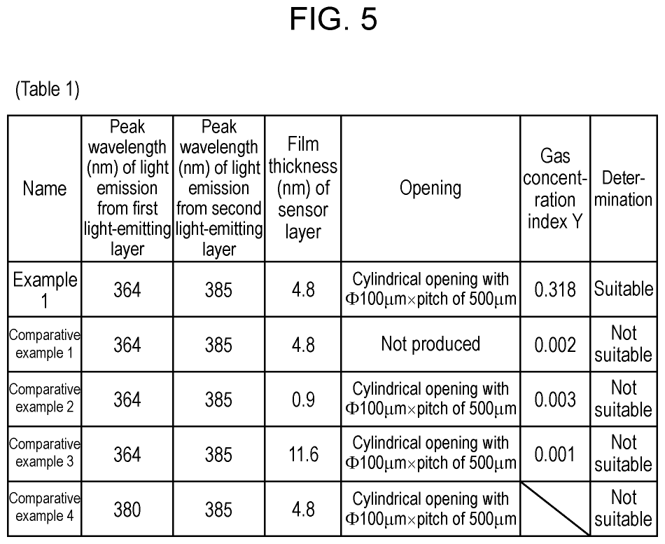

When material systems are different while particle sizes are the same, particles formed of a material having a larger energy gap emit light at a short wavelength side. Furthermore, when materials are the same while particle sizes are different, due to the quantum size effect, particles with a smaller particle size emit light at a short wavelength side, and particles with a larger particle size emit light at a long wavelength side. Assuming that semiconductor nanoparticles that emit light on a short wavelength side are semiconductor nanoparticles A and semiconductor nanoparticles that emit light on a long wavelength side are semiconductor nanoparticles B, in a state in which a distance between the semiconductor nanoparticles A and the semiconductor nanoparticles B is sufficiently far from each other, each emission spectrum of the semiconductor nanoparticles A and the semiconductor nanoparticles B appears at each emission peak intensity. In a case in which a distance between the semiconductor nanoparticles A and the semiconductor nanoparticles B becomes closer than a predetermined distance according to a thickness of the sensor layer, the semiconductor nanoparticles A and B are excited due to this distance, energy transfer from the semiconductor nanoparticles A to the semiconductor nanoparticles B occurs before the semiconductor nanoparticles A emit light, and therefore, energy that is supposed to be emitted from the semiconductor nanoparticles A is used for light emission from the semiconductor nanoparticles B. As a result, an emission peak intensity of the semiconductor nanoparticles A decreases, and an emission peak intensity of the semiconductor nanoparticles B increases (for example, FIG. 3). On the contrary, in a case in which a distance between the semiconductor nanoparticles A and the semiconductor nanoparticles B becomes farther due to swelling of the sensor layer, the semiconductor nanoparticles A and B are excited due to this distance, and therefore, energy transfer from the semiconductor nanoparticles A to the semiconductor nanoparticles B is reduced compared to the case in which the distance therebetween is closer. As a result, an emission peak intensity of the semiconductor nanoparticles A increases and an emission peak intensity of the semiconductor nanoparticles B decreases as compared to the case in which the distance therebetween is closer (for example, FIG. 4).

The same principle applies in a case of using an organic colorant. When the FRET phenomenon occurs, an emission peak intensity of light-emitting particles or colorant molecules which emit light at a short wavelength side decreases, and an emission peak intensity of light-emitting particles or colorant molecules which emit light at a long wavelength side increases. In order to make it easier to confirm the FRET phenomenon, an emission peak wavelength at the short wavelength side and an emission peak wavelength at the long wavelength side are preferably different from each other by 10 nm or more. They are more preferably different from each other by 30 nm or more. When the emission peak wavelengths are closer to each other by less than 10 nm, these emission peak wavelengths overlap, and thereby a change in emission peak intensity in each of the emission peak wavelengths is unlikely to be detected.

Using the above-mentioned principle, in the gas sensor element, one of first light-emitting layer 1b and second light-emitting layer 1d is composed of the first light-emitting particles that function as a donor or an acceptor, the other is composed of the second light-emitting particles that function as a donor or an acceptor, and sensor layer 1c is formed between these layers. With this configuration, it is possible to change a distance between the donor light-emitting particles and the acceptor light-emitting particles by changing a film thickness of sensor layer 1c. When a detection target gas is physically or chemically adsorbed on sensor layer 1c, sensor layer 1c swells, and a film thickness of sensor layer 1c is changed. According to this change in film thickness of sensor layer 1c, an emission spectrum of gas sensor element 1 changes due to the FRET phenomenon. Therefore, when an emission spectrum of gas sensor element 1 is measured, it can be converted into an increase in film thickness of sensor layer 1c, that is, an amount of a detection target gas adsorbed. Because the amount of the detection target gas adsorbed on sensor layer 1c depends on a concentration of the detection target gas in the atmosphere, it is possible to detect the concentration of the gas in the atmosphere.

### Gas Detection Device

Next, FIG. 2 is a schematic view showing a configuration of gas detection device 2 formed from gas sensor element 1 according to the first exemplary embodiment. Gas detection device 2 formed from gas sensor element 1 according to the first exemplary embodiment is composed of gas sensor element 1 described above, excitation energy source 2a that causes gas sensor element 1 to emit light, and light receiver 2b that receives light emitted from gas sensor element 1 by excitation energy source 2a.

The members constituting gas detection device 2 will be described below.

### Excitation Energy Source

Gas sensor element 1 is caused to emit light by excitation energy source 2a. A laser light source can be used as excitation energy source 2a. It is also possible to use an LED light source or the like instead of the laser light source, but in this case, in order to increase a detection sensitivity of light emitted from gas sensor element 1, it is preferable to impart selectivity of a wavelength of light energy 2c from excitation energy source 2a by using a wavelength cut-off filter or the like, and thereby inhibiting an influence of an excitation wavelength. When semiconductor nanoparticles are used for any one or both of first light-emitting layer 1b and second light-emitting layer 1d of gas sensor element 1, an intensity of an excitation spectrum of the semiconductor nanoparticles is large in a short wavelength range, and therefore, a wavelength of excitation energy source 2a is preferably greater than or equal to 200 nm and less than or equal to 600 nm.

In FIG. 2, excitation energy source 2a is disposed at a certain angle and a certain distance from a film surface of gas sensor element 1, but the angle and the distance are not limited thereto.

### Light Receiver

Light receiver 2b receives light emitted from gas sensor element 1 by excitation energy source 2a. As light receiver 2b, it is possible to use a spectroscope in which a condenser lens, an optical fiber, and the like are combined. Furthermore, instead of the spectroscope, it is possible to use a CCD, a CMOS, an image sensor, and the like, which are capable of analyzing light emission 2d from gas sensor element 1 by chromaticity and brightness and calculating chromaticity and brightness.

### Gas Detection Method

Next, a gas detection method in the exemplary embodiment will be described.

(1) First, gas sensor element 1 is irradiated with light by excitation energy source 2a so that gas sensor element 1 is caused to emit light, and a light-emitting state of gas sensor element 1 is recorded by light receiver 2b as a state before gas sensor element 1 is brought into contact with a detection target gas.

(2) Thereafter, after the detection target gas is brought into contact with gas sensor element 1, gas sensor element 1 is irradiated with light by excitation energy source 2a again so that gas sensor element 1 is caused to emit light, and a light-emitting state of gas sensor element 1 is recorded by light receiver 2b.

(3) By comparing the light-emitting states of gas sensor element 1 before and after it is brought into contact with the detection target gas, it is possible to determine whether or not gas sensor element 1 has detected the detection target gas.

In FIG. 2, the light receiver faces the gas sensor element from a front and is disposed at a certain distance therefrom, but these conditions are not limited thereto as long as light emission from the gas sensor element can be detected.

Therefore, according to the present exemplary embodiment, even when a concentration of a detection target gas is 0.1 ppm or less, a film thickness of sensor layer 1c is changed before and after the detection target gas is brought into contact with gas sensor element 1, and emission spectra of first light-emitting layer 1b and second light-emitting layer 1d which are measured by light receiver 2b are changed. Accordingly, a gas at a concentration of 0.1 ppm or less can be detected.

### EXAMPLES

Hereinafter, examples will be described in detail.

### Example 1

A gas sensor element was manufactured by the following manufacturing method.

### Method for Manufacturing Gas Sensor Element

A quartz glass substrate on which a PDDA/PAA film was formed was used for supporting base material 1a. Hereinafter, a method for producing supporting base material 1a will be described.

(1) In order to impart film forming properties of first light-emitting layer 1b to the quartz glass substrate with 6.5 mm×17.5 mm×0.8 mm, the quartz glass substrate was ultrasonically cleaned with acetone and methanol in this order, thereafter, nitrogen gas was sprayed thereto to dry it, the dried substrate was immersed in a piranha solution heated to 150° C. (a 3:1 mixed solution of 96% sulfuric acid and 30% hydrogen peroxide solution) for 90 minutes, and thereby hydroxyl groups were provided on a surface of the substrate.

(2) Thereafter, according to the LBL method, the quartz glass substrate was immersed in an aqueous solution of 0.87 wt % PDDA (polydiallyldimethylammonium chloride) for 10 minutes, thereafter, the substrate was washed with ultrapure water, the washed substrate was immersed in an aqueous solution of PAA (polyacrylic acid) diluted with ultrapure water for 10 minutes so that an optical absorption intensity was set to 0.05, the substrate was washed again with ultrapure water to form a PDDA/PAA film on the surface of the quartz glass substrate, and thereby the quartz glass substrate having the surface on which the PDDA/PAA film was formed was produced.

A layer on which ZnSe semiconductor nanoparticles were laminated was used for first light-emitting layer 1b. Hereinafter, a method for producing first light-emitting layer 1b will be described.

(3) According to a solvothermal synthesis method, ZnSe semiconductor nanoparticles in which NAC (N-acetyl-L-cysteine) was used for as a ligand were produced. An emission peak wavelength of these semiconductor nanoparticles was 364 nm, and they were cationic due to the nature of the ligand.

(4) According to the LBL method, supporting base material 1a was immersed in an aqueous solution in which the semiconductor nanoparticles were dispersed for 20 minutes, and thereafter, supporting base material 1a was washed with ultrapure water to form first light-emitting layer 1b into a film on supporting base material 1a.

A layer on which PDDA and PAA were alternately laminated was used for sensor layer 1c. Hereinafter, a method for producing sensor layer 1c will be described.

(5) In the same procedure as when film forming properties of first light-emitting layer 1b were imparted to supporting base material 1a, film formation was repeated in the order of PDDA and PAA as one layer so that five layers of PDDA and five layers PAA were formed into a film on first light-emitting layer 1b.

A layer on which ZnSe semiconductor nanoparticles were laminated was used for second light-emitting layer 1d. Hereinafter, a method for producing second light-emitting layer 1d will be described.

(6) According to a solvothermal synthesis method, ZnSe semiconductor nanoparticles in which NAC (N-acetyl-L-cysteine) was used for as a ligand were produced. These ZnSe semiconductor nanoparticles were heated for a longer time than when producing the ZnSe semiconductor nanoparticles of first light-emitting layer 1b, and therefore, a particle size thereof was larger, and an emission peak wavelength was shifted to a long wavelength side due to the quantum size effect and was 385 nm.

(7) A film was formed on sensor layer 1c by the same LBL method as in first light-emitting layer 1b.

A layer on which silicon dioxide was formed was used for protective layer 1e. Hereinafter, a method for producing protective layer 1e will be described.

(8) By applying a general ion milling method, a silicon dioxide target disposed to a front surface of an ion gun at a certain angle was milled with argon ions, a surface of second light-emitting layer 1d was installed at the sputtering destination of the silicon dioxide target, and thereby a film was formed with a film thickness of 500 nm.

(9) Regarding opening 1f, a photoresist was formed on a surface of protective layer 1e by a spin coater method, a cylindrical opening having a diameter of φ100 μm was produced in a grid pattern at a pitch of 500 μm by using an exposure device or an ion milling device, and the opening was caused to penetrate in the in-plane vertical direction Z until sensor layer 1c was exposed.

Next, a gas detection device was manufactured with the following configuration.

### Configuration of Gas Detection Device

A laser light source having an emission wavelength of 300 nm was used for excitation energy source 2a. The laser light source was installed at a position apart from gas sensor element 1 by a distance of 50 cm while setting an incident angle of the laser on the film surface of gas sensor element 1 to 45°.

As light receiver 2b, a combination of a spectroscope, a condenser lens, and an optical fiber was used. The condenser lens was installed at a position apart from gas sensor element 1 by a distance of 5 cm while causing it to face the film surface of gas sensor element 1 from a front.

### Evaluation Method

Next, an evaluation method will be specifically described.

In order to investigate whether gas sensor element 1 can detect an ammonia gas when gas sensor element 1 is brought into contact with a mixed gas of a dry nitrogen gas and 0.005 ppm of an ammonia gas, gas detection device 2 described above was installed to measure emission spectra of the gas sensor element before it was brought into contact with the mixed gas and after it was brought into contact with the mixed gas for 30 seconds, and thereby a gas concentration index Y to be described later was calculated. When the gas concentration index Y was 0.005 or more, it was determined that the gas could be detected, and when the gas concentration index was less than 0.005, it was determined that the gas could not be detected.

The emission spectra of gas sensor element 1 before and after gas sensor element 1 was brought into contact with the detection target gas was measured in accordance with a method in General rules for fluorometric analysis of the Japanese Industrial Standards (JIS K 0120), and the gas concentration index Y shown in Formula (1) was calculated to investigate whether or not the detection target gas could be detected by gas sensor element 1. As shown in FIG. 3, I₁ is an emission intensity at a peak wavelength on a short wavelength side of gas sensor element 1 before it was brought into contact with the detection target gas, and I₂ is an emission intensity at a peak wavelength on a long wavelength side thereof. Furthermore, as shown in FIG. 4, I₁′ is an emission intensity at a peak wavelength on a short wavelength side of the gas sensor element after it was brought into contact with the detection target gas, and I₂′ is an emission intensity at a peak wavelength on a long wavelength side thereof. Table 1 of FIG. 5 shows conditions and calculation results of the gas concentration index Y in the example and comparative examples.

$$Gas concentration index \text{:} Y = \frac{\vert {I}_{1}^{′} - {I}_{1} \vert + \vert {I}_{2}^{′} - {I}_{2} \vert}{{I}_{1} + {I}_{2}}$$

(1)

### Comparative Example 1

A gas concentration index Y was calculated by measuring emission spectra of gas sensor element 1 in the same manner as in the example except that opening 1f was not produced. The results are shown in Table 1 of FIG. 5.

Based on Example 1 and Comparative Example 1, it became clear that sensor layer 1c could not adsorb the detection target gas when opening 1f was not produced, and therefore, gas sensor element 1 could not detect 0.005 ppm of the gas.

### Comparative Example 2

A gas concentration index Y was calculated by measuring emission spectra of gas sensor element 1 in the same manner as in the example except that PDDA and PAA were used for sensor layer 1c, and in the order of PDDA and PAA, one layer of PDDA and one layer of PAA were formed into a film on first light-emitting layer 1b by the LBL method. The results are shown in Table 1 of FIG. 5.

Based on Example 1 and Comparative Example 2, it became clear that when a film thickness of sensor layer 1c was less than 1 nm, sensor layer 1c could not sufficiently adsorb the detection target gas, and the film thickness of sensor layer 1c was not sufficiently changed, and therefore, gas sensor element 1 could not detect 0.005 ppm of the gas.

### Comparative Example 3

A gas concentration index Y was calculated by measuring emission spectra of gas sensor element 1 in the same manner as in the example except that PDDA and PAA were used for sensor layer 1c, and in the order of PDDA and PAA as one layer, 25 layers of PDDA and 25 layers of PAA were formed into a film on the first light-emitting layer by the LBL method. The results are shown in Table 1 of FIG. 5.

Based on Example 1 and Comparative Example 3, it became clear that when a film thickness of sensor layer 1c was 100 nm or more, a change in emission spectra, which occurs due to the FRET phenomenon before and after sensor layer 1c adsorbs the detection target gas, was not recognized, and therefore, gas sensor element 1 could not detect 0.005 ppm of the gas.

### Comparative Example 4

Emission spectra of gas sensor element 1 were measured in the same manner as in the example except that ZnSe semiconductor nanoparticles, which had an emission peak wavelength of 380 nm and were produced by the solvothermal synthesis method, were used for particles constituting first light-emitting layer 1b. As a result, light emission on a short wavelength side and light emission on a long wavelength side overlapped, and therefore, it was not possible to distinguish peaks for each of the light emissions, and a gas concentration index Y could not be calculated. Based on Example 1 and Comparative Example 4, it became clear that unless a peak wavelength of light emission from second light-emitting layer 1d is different from a peak wavelength of light emission from first light-emitting layer 1b by at least 10 nm or more, gas sensor element 1 cannot detect 0.005 ppm of the gas.

Therefore, it became clear that gas sensor element 1 becomes able to detect 0.005 ppm or more of the gas in a case where gas sensor element 1 has the opening that penetrates the laminated structure from protective layer 1e until at least sensor layer 1c is exposed, a film thickness of sensor layer 1c is greater than or equal to 1 nm and less than or equal to 100 nm, and a peak wavelength of light emission from first light-emitting layer 1b and peak wavelength of light emission from second light-emitting layer 1d are different from each other by 10 nm or more.

The present disclosure includes an appropriate combination of any exemplary embodiment and/or example among the aforementioned various exemplary embodiments and/or examples, and can exert effects of the respective exemplary embodiments and/or examples.

According to the gas sensor element according to the present disclosure, and the gas detection device formed from the gas sensor element according to the present disclosure, it is possible to detect 0.1 ppm or less of a gas. In addition, by imparting selectivity of gas adsorption properties according to the type of gas to the sensor layer, there is a possibility of detecting flammable gas, toxic gas, and molecules that cause odor, which are at a low concentration of 0.1 ppm or less, while distinguishing them.

What is claimed is:

1. A gas sensor element comprising:
a supporting base material;
a first light-emitting layer that is provided on the supporting base material and contains a first light-emitting particle which emits light at a first peak wavelength;
a sensor layer that is provided on the first light-emitting layer and adsorbs gas molecules;
a second light-emitting layer that is provided on the sensor layer and contains a second light-emitting particle which emits light at a second peak wavelength different from the first peak wavelength; and
a protective layer that is provided on the second light-emitting layer,
wherein the gas sensor element has a laminated structure in which the supporting base material, the first light-emitting layer, the sensor layer, the second light-emitting layer, and the protective layer are laminated in this order, and
the laminated structure includes an opening that penetrates a part or entirety of the laminated structure.

2. The gas sensor element of claim 1,
wherein the opening penetrates the laminated structure from the protective layer until at least the sensor layer is exposed.

3. The gas sensor element of claim 1,
wherein a film thickness of the sensor layer is greater than or equal to 1 nm and less than or equal to 100 nm.

4. The gas sensor element of claim 1,
wherein the second peak wavelength of the light, which is emitted from the second light-emitting particle contained in the second light-emitting layer is different from the first peak wavelength of the light, which is emitted from the first light-emitting particle contained in the first light-emitting layer, by at least 10 nm or greater, when measured in accordance with a method in General rules for fluorometric analysis of the Japanese Industrial Standards (JIS K 0120).

5. A gas detection device comprising:
the gas sensor element of claim 1;
an excitation energy source that causes the gas sensor element to emit light; and
a light receiver that receives light emitted from the gas sensor element by the excitation energy source.
